(19) United States
(12) Patent Application Publication
(10) Pub. No.: US 2026/0017906 A1
(43) Pub. Date: Jan. 15, 2026

(54) Systems and Methods for Non-Parametric Optimization of Complex Shapes Using Neural Networks and Differentiable Morphing

(71) Applicant: Ansys, Inc., Canonsburg, PA (US)

(72) Inventors: Louis Verret, Paris (FR); Morgane Bourgeois, Paris (FR); Thibaut Munzer, Paris (FR); Antoine Nuttinck, Paris (FR); Ahmed Mazari, Paris (FR)

(21) Appl. No.: 18/947,065

(22) Filed: Nov. 14, 2024

Related U.S. Application Data
(60) Provisional application No. 63/670,198, filed on Jul. 12, 2024.

(51) Int. Cl. G06T 19/20; G06T 17/20

(52) U.S. Cl. CPC G06T 19/20; G06T 17/20; G06T 2210/44; G06T 2219/2021

(57) ABSTRACT

Systems and methods are provided for generating a geometric shape. A mesh is defined that includes a plurality of mesh nodes. A plurality of control points are defined based on the mesh. The control points and mesh nodes are related through a differentiable function. A neural network is applied to the mesh. The neural network predicts one or more physical fields of the mesh based on the mesh and a parameter. A plurality of gradients of an objective function is calculated based on the one or more physical fields and a position of the plurality of control points. The position of one or more of the plurality of control points is moved based on the plurality of gradients. The movement induces a deformation of the mesh.

### CROSS-REFERENCE TO RELATED APPLICATIONS

This application claims priority to U.S. Provisional Application No. 63/670,198, filed Jul. 12, 2024, entitled “Non-Parametric Optimization of Complex Shapes Using Neural Networks and Differentiable Morphing,” which is incorporated herein by reference in its entirety.

### FIELD

This disclosure is related generally to shape optimization and more generally to non-parametric optimization of complex shapes using neural networks and differentiable morphing.

### BACKGROUND

Physical shapes of certain objects may contribute to their performance and efficiency. For example, a shape of a vehicle, or a particular region of the vehicle, may affect the fluid dynamics of the vehicle. Moreover, a shape of an airplane or a region of the airplane (e.g., an airplane wing) may contribute to the lift or drag realized by the airplane during operation. Optimizing the physical shapes of certain devices to obtain desired properties of the devices is thus crucial for a wide range of applications. For example, it may be advantageous to determine a shape of a car that minimizes the drag of a car, or a shape of an airplane that maximizes the lift-to-drag (L/D) ratio of the airplane. A mesh (e.g., a collection of vertices, edges, and faces that define the shape of an object) may be used to calculate and improve the shape of such objects.

Some methods of improving physical shapes are cumbersome, expensive, and inefficient. For example, some physical solvers may utilize optimization algorithms that require solving multiple partial differential equations (PDEs) at a plurality of iterative steps in the algorithm. Such methods may be prohibitively expensive or time-consuming when calculating physical shapes based on complex physics such as computational fluid dynamics (CFD) and physical shapes for large meshes. It may be advantageous to improve the shapes of objects based on parameters of the objects that are predicted based on training datasets.

### SUMMARY

Systems and methods are provided for generating a geometric shape. A mesh is defined that includes a plurality of mesh nodes. A plurality of control points are defined based on the mesh. The control points and mesh nodes are related through a differentiable function. A neural network is applied to the mesh. The neural network predicts one or more physical fields of the mesh based on the mesh and a parameter. A plurality of gradients of an objective function is calculated based on the one or more physical fields and a position of the plurality of control points. The position of one or more of the plurality of control points is moved based on the plurality of gradients. The movement induces a deformation of the mesh.

As another example, a method of generating a geometric shape includes training a neural network with a plurality of training meshes and one or more training physical fields associated with each of the plurality of training meshes. The neural network is applied to a mesh including a plurality of mesh nodes. The neural network generates a predicted physical field of the mesh based on the training meshes and the training physical fields. An objective function is computed based on the predicted physical field. One or more of the mesh nodes is moved based on the objective function.

### DESCRIPTION OF DRAWINGS

FIG. 1 is a diagram depicting a flowchart of a process of generating a geometric shape, in accordance with some embodiments.

FIG. 2A is a diagram depicting a flowchart of a process of generating a geometric shape, in accordance with some embodiments.

FIG. 2B is a diagram depicting a flowchart of a process of optimizing a geometric shape, in accordance with some embodiments.

FIG. 3A depicts an isometric view of an example mesh, in accordance with some embodiments.

FIG. 3B depicts a side view of an example mesh, in accordance with some embodiments.

FIG. 3C depicts a front view of an example mesh, in accordance with some embodiments.

FIG. 4A depicts an isometric view of an example mesh with predicted physical fields, in accordance with some embodiments.

FIG. 4B depicts a side view of an example mesh with predicted physical fields, in accordance with some embodiments.

FIG. 4C depicts a front view of an example mesh with predicted physical fields, in accordance with some embodiments.

FIG. 5A depicts an isometric view of an example mesh with a local morphing box, in accordance with some embodiments.

FIG. 5B depicts a side view of an example mesh with a local morphing box, in accordance with some embodiments.

FIG. 5C depicts a front view of an example mesh with a local morphing box, in accordance with some embodiments.

FIG. 6A depicts an isometric view of an example mesh with a plurality of control points, in accordance with some embodiments.

FIG. 6B depicts a side view of an example mesh with a plurality of control points, in accordance with some embodiments.

FIG. 6C depicts a front view of an example mesh with a plurality of control points, in accordance with some embodiments.

FIG. 7A depicts an isometric view of an example deformed mesh, in accordance with some embodiments.

FIG. 7B depicts a side view of an example deformed mesh, in accordance with some embodiments.

FIG. 7C depicts a front view of an example deformed mesh, in accordance with some embodiments.

FIG. 8A depicts an isometric view of an example deformed mesh with physical fields, in accordance with some embodiments.

FIG. 8B depicts a side view of an example deformed mesh with physical fields, in accordance with some embodiments.

FIG. 8C depicts a front view of an example deformed mesh with physical fields, in accordance with some embodiments.

FIG. 9 depicts an example method of generating a geometric shape, in accordance with some embodiments.

FIG. 10 depicts an example method of generating a geometric shape, in accordance with some embodiments.

### DETAILED DESCRIPTION

As noted above, some systems and methods used to change (i.e., improve) the shape of an object are cumbersome and expensive. For example, some systems and methods involve tedious and complex calculations at each iteration of a continual morphing process. Moreover, some systems and methods involve continual design changes to a mesh by a human based on simulations or calculations applied to the mesh. Such systems and methods may involve continually applying the simulations to the mesh after subsequent design changes. Furthermore, some systems and methods may be computationally inefficient, such that typical engineering practices may include selecting a limited number of hand-designed shapes, or computing improvements for shapes that can be parameterized using only a few degrees of freedom. Example systems and methods for shape optimization are described in U.S. Pat. No. 11,768,983, which is hereby incorporated by reference in its entirety.

Certain implementations provide shape optimization using a parametric approach. There, geometrical parameters may be formulated to define a space of shapes inside which an optimization occurs. Such parametric implementations tend to be tedious and limited in their practical scope. For example, the process of identifying meaningful parameters is often not practical for shapes that include fine-grained details. Moreover, optimization at the parameter level may not allow for exploration outside of the predetermined space.

In other implementations, non-parametric techniques, such as an adjoint method, may be utilized to solve optimization problems (e.g., dual optimization problems). In one example, an adjoint method computes gradients with respect to mesh nodes and then leverages first-order optimization algorithms. Specifically in one example, an adjoint method solves two partial differential equations at each optimization step. This process may, in some instances, become prohibitively time and resource expensive when operating on meshes with many nodes and complex physics (e.g., CFD).

Example systems and methods disclosed herein utilize a neural network, alone or in combination with other techniques, to provide shape optimization. In embodiments. systems and methods include training a neural network with a dataset of a plurality of meshes having corresponding physical fields. The trained neural network is used to predict physical fields of a mesh, and the mesh is subsequently deformed based on calculations performed from the predicted physical fields.

Systems and methods disclosed herein can be more computationally efficient than some shape optimization methods, which in some examples perform optimization via continual solving of complex equations. In contrast, in certain systems and methods herein, one or more trained neural networks may operate as universal function approximators. In such implementations, a system including the neural network(s) may avoid a need to continually solve those complex equations directly, in whole or in part. Instead, one or more trained neural networks can approximate the functional space of those equations to predict physics of a given mesh based on a training dataset. Moreover, systems and methods disclosed herein may allow for smooth, local, and/or symmetrical deformations of mesh nodes while maintaining continuity with other regions of the mesh. Thus, systems and methods disclosed herein can provide a robust and scalable alternative to some shape optimization methods. Such systems and methods can provide substantial efficiency benefits over other solutions, such as solutions that execute iterative solving of complex operations. In certain examples, time savings of training, optimizing, and then executing a neural network for shape optimization can provide savings on the order of 20 times, 30 times, or more compared to other methods (e.g., an adjoint-only method).

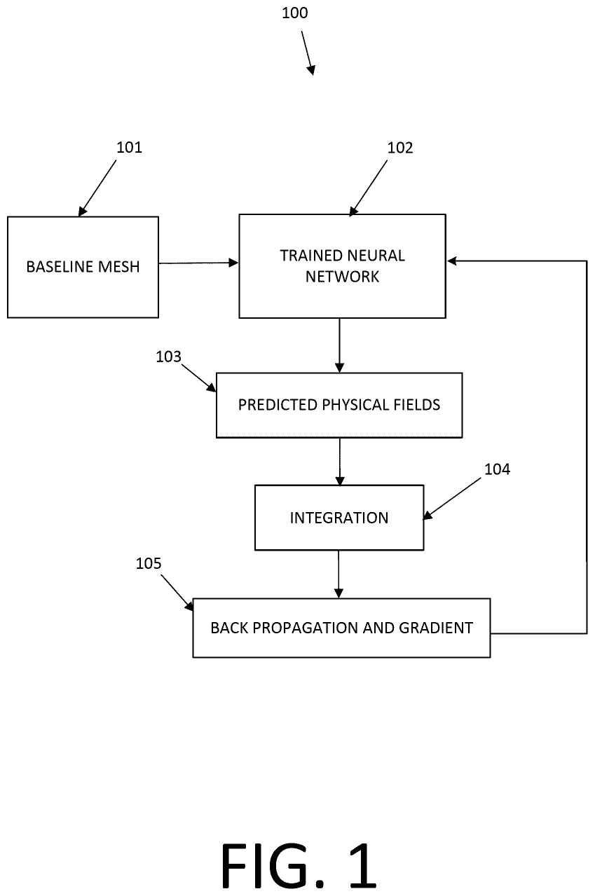

FIG. 1 is a diagram depicting a flowchart of a process of generating a geometric shape, in accordance with some embodiments. The process 100 includes a baseline mesh 101. The baseline mesh 101 may include a plurality of mesh nodes that are a collection of vertices, edges, and faces that define a shape of an object (e.g., a 3-dimensional (3D) object). The baseline mesh 101 may define, for example, a car, a plane, a boat, or any object having a shape which is desired to be improved based on one or more parameters (e.g., pressure drag coefficient (CDp), lift-to-drag ratio (L/D)). The baseline mesh 101 may be received at a trained neural network at 102. The neural network 102 may have been trained with a plurality of training meshes and one or more physical fields of each of the plurality of training meshes. The physical fields of the training meshes may be used to define physical quantities over the mesh nodes of the training meshes. For example, the physical fields of the training meshes may be scalars, vectors, or tensors, and may represent values of one or more parameters of a corresponding area of the training mesh.

Based on the plurality of training meshes with which the neural network 102 was trained, the neural network 102 generates one or more predicted physical fields of the baseline mesh 101 at 103. The predicted physical fields may be used to define physical quantities over the mesh nodes of the baseline mesh 101. As with the physical fields of the training meshes, the predicted physical fields 103 of the baseline mesh 101 may be scalars, vectors, or tensors, and may represent values of one or more parameters of a corresponding area of the baseline mesh 101. For example, the predicted physical fields 103 of the baseline mesh 101 may represent a CDp at each area of the baseline mesh 101.

The process 100 may further include an integration step at 104. Integration 104 may include computing an objective function. The objective function may be, for example, a scalar computed based on the predicted physical fields 103 and may represent a physical criterion of which the process 100 is designed to minimize or maximize. For example, the objective function may represent an overall drag of the baseline mesh 101 as a whole, which the process 100 is designed to minimize. Computing the objective function may involve integrating the predicted physical fields 103 with the use of a probabilistic method (e.g., probabilistic integration, Monte Carlo simulation).

The process 100 further includes back propagation and gradient computation at 105. At 105, the gradients of the objective function may be computed for a plurality of points (e.g., control points) related to the baseline mesh 101, as described below. A differentiation system (e.g., Autograd) may be employed to calculate the gradients of the objective function. Based on a direction of each of the plurality of gradients, one or more of the plurality of points may be moved. This movement may cause a deformation in the baseline mesh 101, as the mesh nodes and the plurality of points are related through a differentiable function. This deformed baseline mesh 101 may be received at the trained neural network 102, and the process 100 may repeat until the one or more parameters are maximized, minimized, or reach a predetermined level.

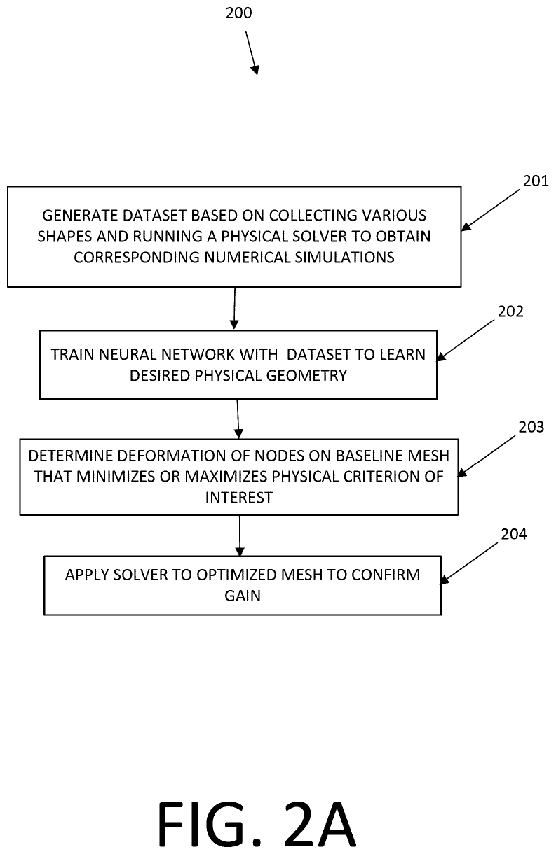

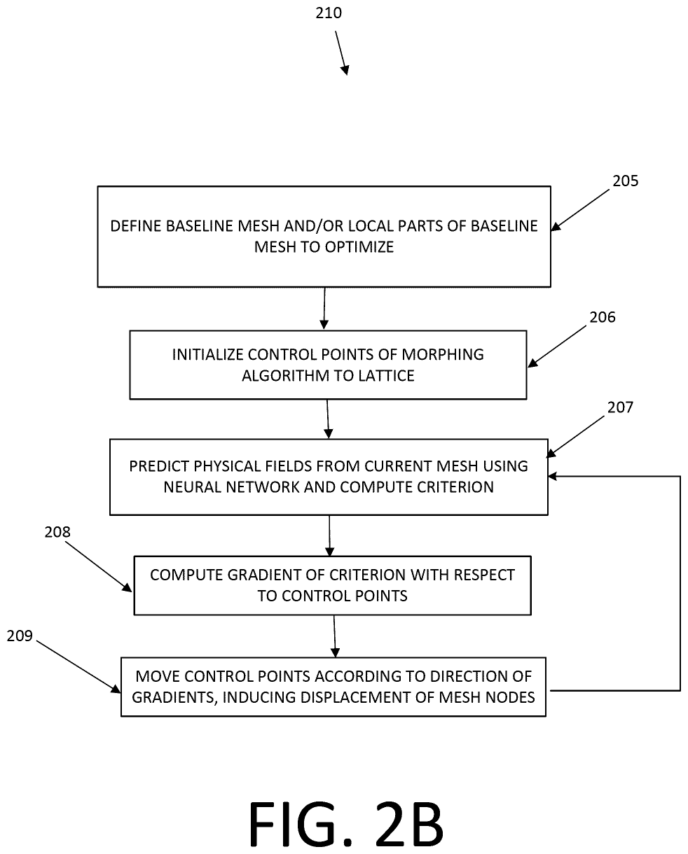

FIG. 2A is a diagram depicting a flowchart of a process of generating a geometric shape, in accordance with some embodiments. The process 200 includes generating a dataset based on collecting various shapes and running a physical solver to obtain corresponding numerical simulations at 201. The shapes may be, for example, a plurality of training meshes. Furthermore, physical fields representing one or more parameters may be generated based on the numerical simulations. At 202, a neural network is trained with the dataset generated at 201 to learn a desired physical geometry. For example, the desired physical geometry may be learned by determining a geometry of the various shapes or portions of the various shapes that minimizes or maximizes the objective function described above with respect to FIG. 1.

At 203, the deformation of mesh nodes on a baseline mesh that minimizes or maximizes a physical criterion of interest (i.e., the objective function) is determined to generate an optimized mesh. This determination may be based on the desired physical geometry that was learned at 202. At 204, a physical solver may be applied to the optimized mesh to confirm the gain (e.g., improvement in the physical criterion with respect to the baseline mesh). In some example, steps within the process 200 may be performed in an order that differs from that depicted in FIG. 2A.

FIG. 2B is a diagram depicting a flowchart of a process of optimizing a geometric shape, in accordance with some embodiments. The process 210 depicted in FIG. 2B may represent step 203 depicted in FIG. 2A. At 205, a baseline mesh and/or local parts of the baseline mesh to optimize are defined. At 206, control points of a morphing algorithm are initialized to a lattice. At 207, physical fields from the current mesh (e.g., the baseline mesh and subsequent deformed meshes received at 207) are predicted using the neural network. Furthermore, the criterion (e.g., objective function) is computed. At 208, a gradient of the criterion is computed with respect to the control points.

At 209, one or more of the control points are moved based on the direction of the gradients. As described above, the control points and the mesh nodes are related through a differentiable function. Accordingly, the movement of one or more of the control points induces a smooth displacement of the mesh nodes and thus a smooth deformation of the mesh. As shown by the arrow from 209 to 207, the deformed mesh is received at 207, and physical fields are predicted for the deformed mesh (e.g., current mesh) using the neural network, and the criterion is computed for the deformed mesh. The process 210 may repeat until the criterion is maximized, minimized, or reaches a predetermined threshold.

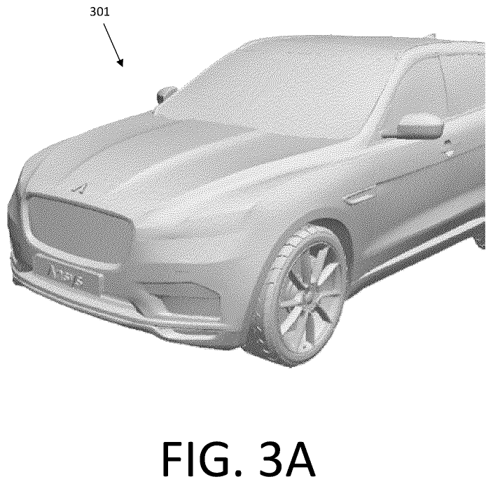

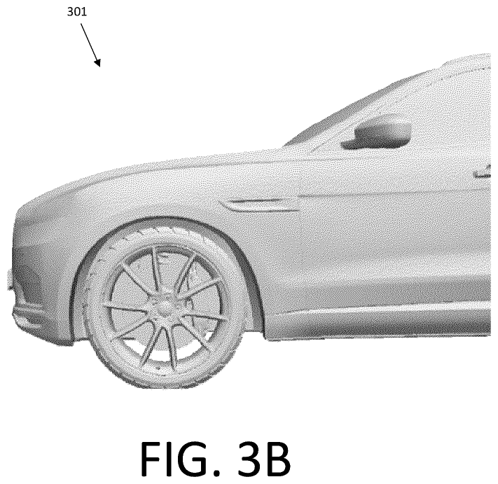

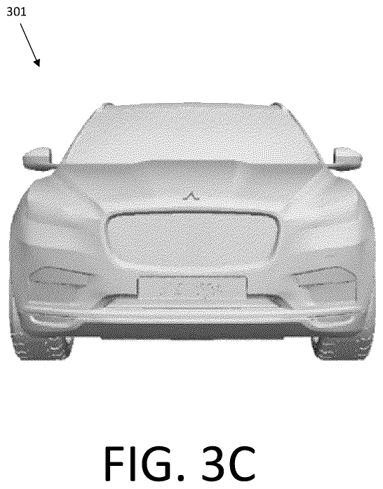

FIG. 3A depicts an isometric view of an example mesh, in accordance with some embodiments. FIG. 3B depicts a side view of the example mesh, and FIG. 3C depicts a front view of the example mesh, in accordance with some embodiments. As described above with respect to FIG. 1, the example mesh 301 may include a plurality of mesh nodes that are a collection of vertices, edges, and faces that define a shape of an object. As shown in FIGS. 3A, 3B, and 3C, the example mesh 301 is that of a car. However, the example mesh 301 could represent any object (e.g., a 3D object), such as an airplane, a boat, or bicycle. The mesh 301 may be generated, for example, by a computer algorithm or computer-aided design (CAD) software.

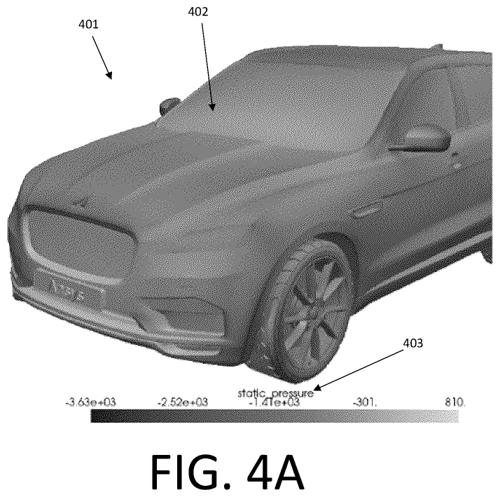

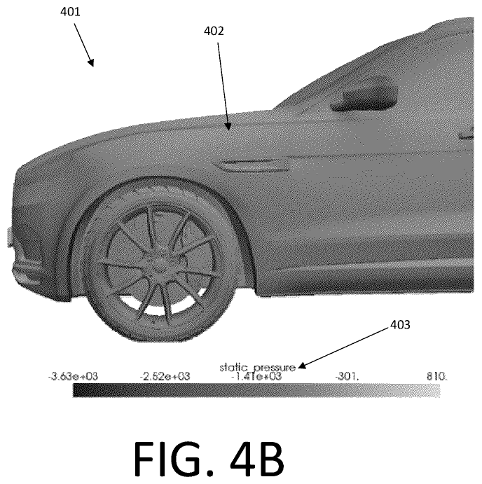

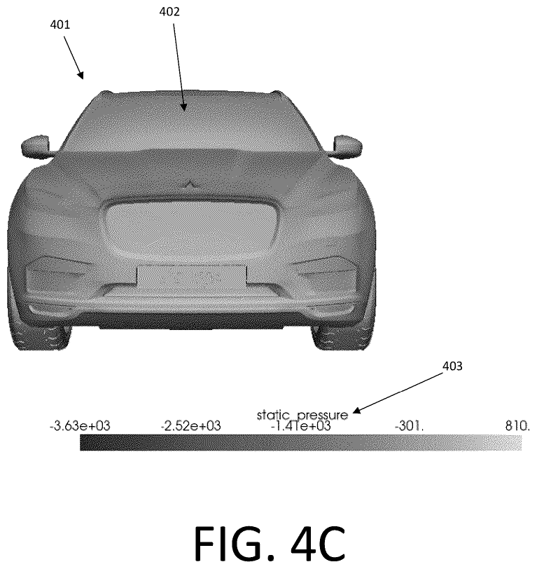

FIG. 4A depicts an isometric view of an example mesh with predicted physical fields, in accordance with some embodiments. FIG. 4B depicts a side view of the example mesh with predicted physical fields, and FIG. 4C depicts a front view thereof, in accordance with some embodiments. As described above with respect to FIG. 1, the predicted physical fields 402 of the mesh 401 may be predicted by the trained neural network 102. Specifically, the trained neural network 102 may predict the physical fields 402 of the mesh 401 based on a dataset of a plurality of training meshes and one or more physical fields of each of the plurality of training meshes. The physical fields of the training meshes may have been calculated, for example, by a physical solver.

The predicted physical fields 402 of the mesh 401 may be used to define physical quantities over the mesh nodes. For example, the predicted physical fields 402 of the mesh 401 may be scalars, vectors, or tensors, and may represent values of one or more parameters of a corresponding area of the mesh 401. In the examples depicted in FIGS. 4A, 4B, and 4C, the parameter 403 is static pressure. However, the predicted physical fields 402 may represent values of any of one or more parameters 403.

Moreover, as shown in FIGS. 4A, 4B, and 4C, the predicted physical fields 402 may be represented by shading of different intensities and/or colors throughout the mesh nodes of the mesh 401. The example mesh 401 may have predicted physical fields 402 representing values of the parameter 403 that differ depending on a contour of a particular region of mesh nodes. For example, the parameter 403 (e.g., static pressure) may have a lower value at and around a smooth surface of the mesh 401, while the parameter 403 may have a higher value at and around uneven or rough contours of the mesh 401.

Based on the predicted physical fields 402, the objective function may be calculated. As described above, the objective function may be a scalar computed based on the predicted physical fields 103 and may represent the physical criterion (e.g., static pressure) which is sought to be minimized or maximized. For example, the objective function may be determined by computing an integral of the predicted physical fields 402 with a probabilistic model, such as a Monte Carlo simulation.

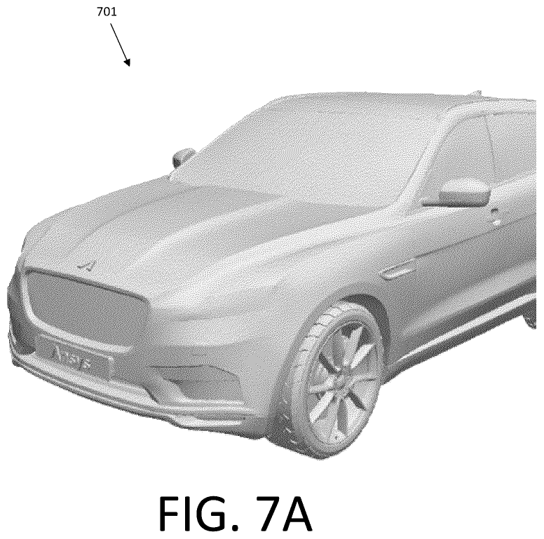

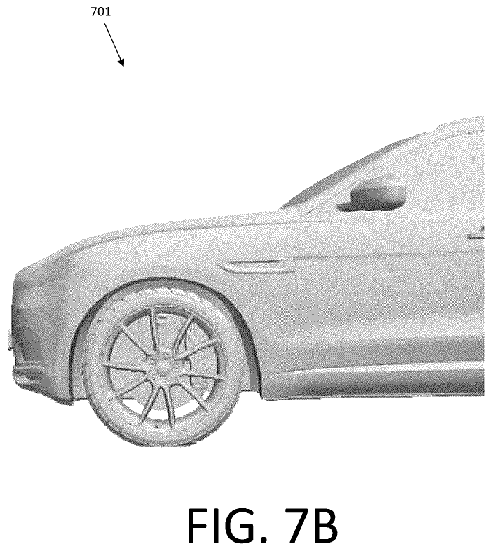

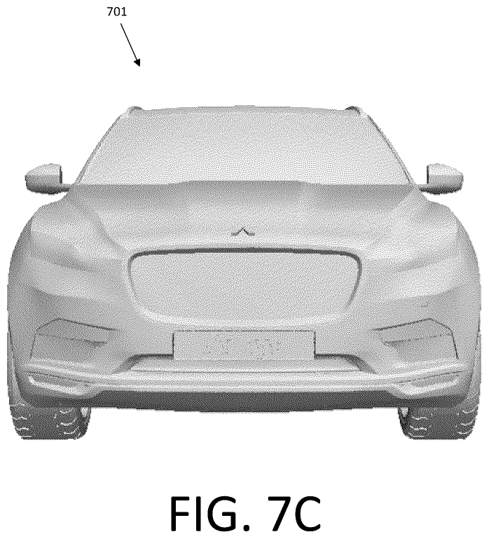

Additionally, one or more constraints may be defined for the mesh nodes of the mesh 401. The constraints may be a region of the mesh 401 that has a fixed (e.g., unchanging) contour, or a region of the mesh 401 having a contour that must remain within predefined boundaries. For example, the constraints may be based on a design choice, an emblem, or legal or regulatory requirements of the contour of the object represented by the mesh 401. The deformation of the mesh 401 described below may be limited such that the subsequently deformed mesh 701 (FIGS. 7A, 7B, 7C) has a contour that remains within the constraints.

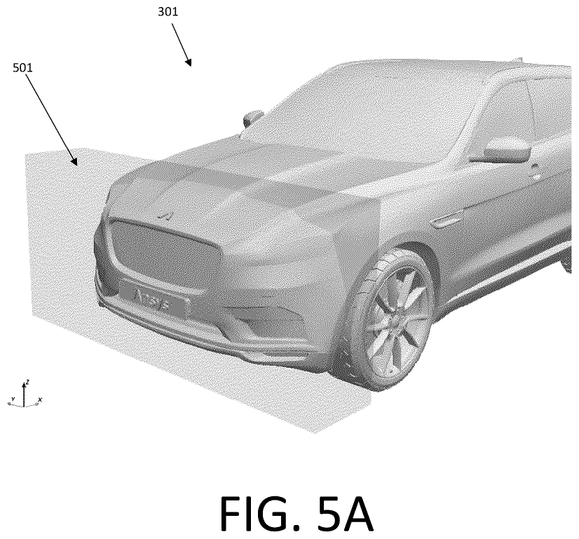

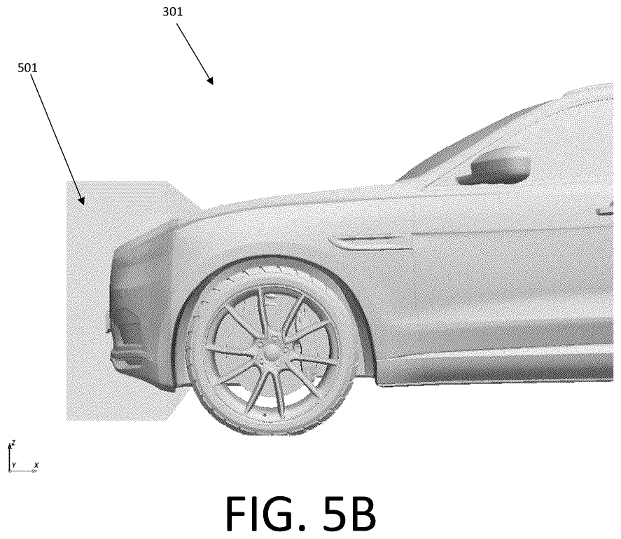

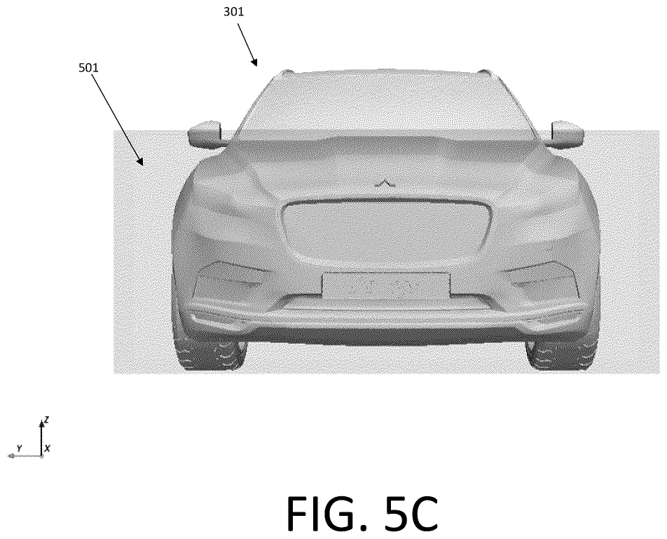

FIG. 5A depicts an isometric view of an example mesh with a local morphing box, in accordance with some embodiments. FIG. 5B depicts a side view of the example mesh with the local morphing box, and FIG. 5C depicts a front view thereof, in accordance with some embodiments. The local morphing box 501 depicted in FIGS. 5A, 5B, and 5C may surround a region of the mesh 301 to be deformed (i.e., improved). In some examples, the local morphing box 501 may surround the entire mesh. Mesh nodes outside of the local morphing box 501 may be fixed (e.g., not deformed by the systems and processes described herein).

In some examples, a plurality of local morphing boxes 501 surround various differing regions of the mesh 301. Mesh nodes at an edge of the local morphing box 501 may also remain fixed to ensure continuity with the regions of the mesh 301 adjacent to the local morphing box 501. Furthermore, the slope (e.g., gradient) of the mesh nodes at the edge of the local morphing box 501 may remain fixed to ensure smooth (e.g., differentiable) continuity with the regions of the mesh 301 adjacent to the local morphing box 501.

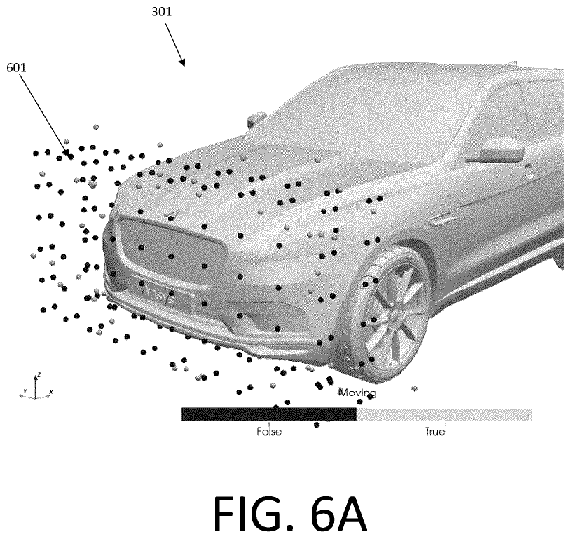

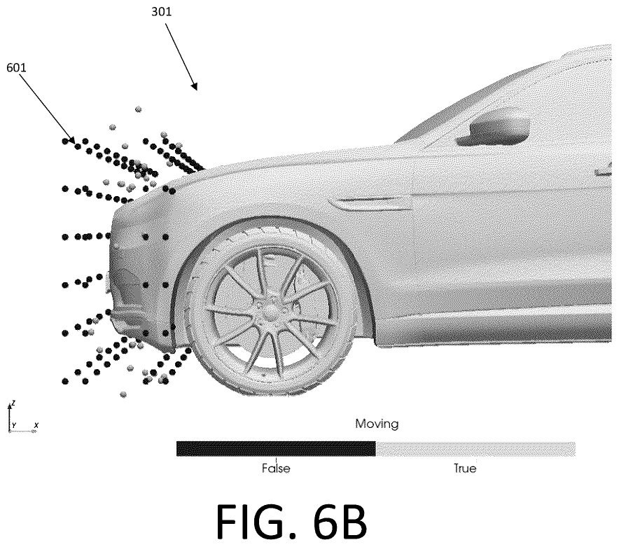

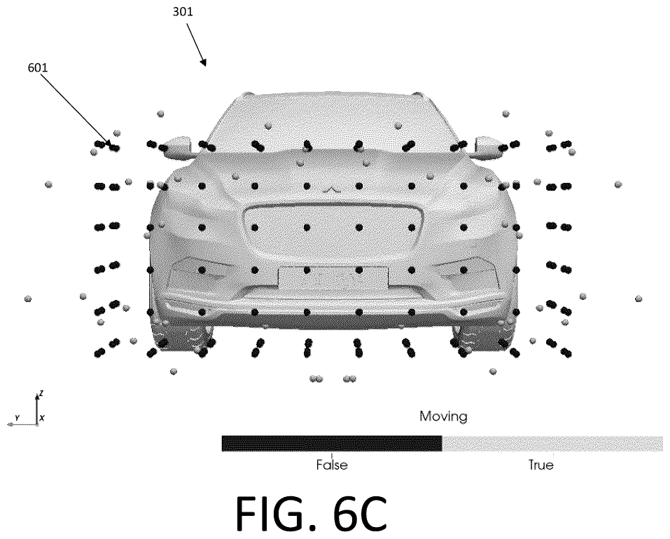

FIG. 6A depicts an isometric view of an example mesh with a plurality of control points, in accordance with some embodiments. FIG. 6B depicts a side view of the example mesh with a plurality of control points, and FIG. 6C depicts a front view thereof, in accordance with some embodiments. As shown in FIGS. 6A, 6B, and 6C, a plurality of control points 601 are included in the region of the local morphing box depicted in FIGS. 5A, 5B, and 5C. The control points 601 may be based on and utilized by a morphing algorithm (e.g., free-form deformation (FFD), radial basis function (RBF)). The position of each of the plurality of control points 601 may be initialized based on the position of the mesh nodes of the baseline mesh 301. The control points 601 and mesh nodes of the mesh 301 may be related through a differentiable function. The control points 601 may form a lattice.

After the position of each of the plurality of control points 601 is initialized, the trained neural network 102 may generate the predicted physical fields, as described above with respect to FIGS. 4A, 4B, and 4C. Furthermore, the objective function may be computed after the initialization of the position of the control points 601. Gradients of the objective function are computed with respect to the position of the control points 601. The computation of the gradients may be performed, for example, by a differentiation system such as Autograd.

Based on the direction and/or magnitude of the gradients of the objective function, the position of one or more of the control points 601 may be moved. Because the control points 601 and the mesh nodes are related through a differentiable function, the movement of the control points 601 induces a smooth deformation of the mesh 301. The movement of one or more of the control points 601 may be limited so as to not result in a deformed mesh 701 (FIGS. 7A, 7B, 7C) having a contour that is outside of the one or more constraints (described above with respect to FIGS. 4A, 4B, and 4C). As shown in FIGS. 6A, 6B, and 6C, some of the plurality of control points 601 may be moving control points (denoted by “true” in the illustrated embodiments), while some of the plurality of control points 601 may not be moving control points (denoted by “false” in the illustrated embodiments). The moving control points may move, and thereby deform the mesh 301, based on the corresponding computed gradients. For example, the gradients that caused the moving control points to move may have a particular direction, or may have a magnitude above a predetermined threshold. In contrast, the control points 601 that do not move may have a corresponding gradient that has a magnitude below the predetermined threshold.

FIG. 7A depicts an isometric view of an example deformed mesh, in accordance with some embodiments. FIG. 7B depicts a side view of the example deformed mesh, and FIG. 7C depicts a front view thereof, in accordance with some embodiments. As compared with the baseline mesh 301 depicted in FIGS. 3A, 3B, and 3C, the deformed mesh 701 shown in FIGS. 7A, 7B, and 7C may have a different contour. For example, the deformed mesh 701 may have a contour having different curvatures.

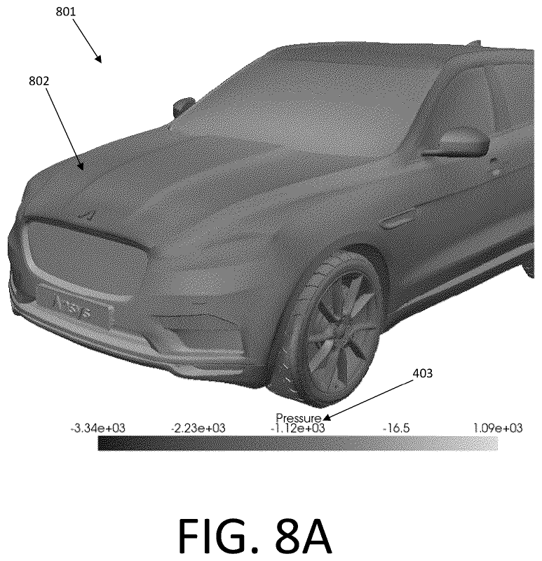

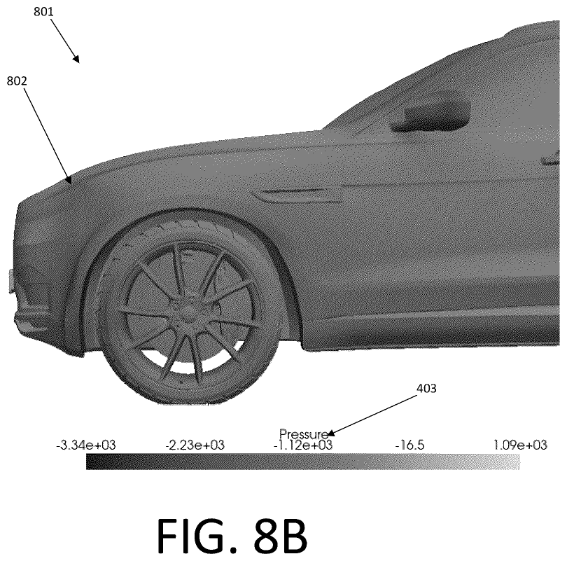

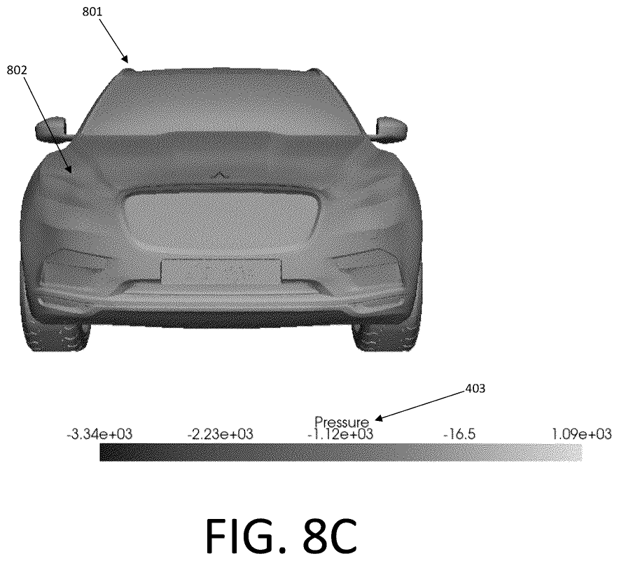

FIG. 8A depicts an isometric view of an example deformed mesh with physical fields, in accordance with some embodiments. FIG. 8B depicts a side view of the example deformed mesh with physical fields, and FIG. 8C depicts a front view thereof, in accordance with some embodiments. The contour of the deformed mesh 701 may be computed based on receiving the deformed mesh 701 at the trained neural network 102, as shown in FIG. 1. The deformed mesh may include physical fields 402 differing from those of the baseline mesh 401 (FIG. 4).

Furthermore, the contour of the deformed mesh 701 may result in the objective function computed based on the physical fields 802 of the deformed mesh 701 to differ from the objective function computed based on the physical fields 402 of the baseline mesh 401. The differing objective function may be caused by, for example, the deformed mesh 701 having an improved property (e.g., drag) compared with the baseline mesh 401. As depicted in FIGS. 1 and 2B, the deformed mesh 701 may be continually received at the trained neural network 102 and subsequently deformed further until convergence of the objective function is realized by the subsequent deformed mesh 701.

Once convergence of the objective function is realized, the physical fields 802 of the deformed mesh 701 may be verified. For example, a physical solver may be applied to the deformed mesh 701 to verify that the physical fields 802 predicted by the trained neural network 102 are accurate, or within a predetermined threshold. If the verification of the deformed mesh 701 confirms that the physical fields 802 are accurate or within a predetermined threshold, the process described herein may conclude, and the deformed mesh 701 may be used, for example, as a final design (e.g., for a consumer product such as a car or airplane). Furthermore, the deformed mesh 701 may be subsequently added to the training dataset and used to further train the trained neural network 102. If the verification of the deformed mesh 701 does not confirm that the physical fields 802 are accurate or within the predetermined threshold, the trained neural network 102 may again be applied to the deformed mesh 701 and the deformed mesh 701 may be deformed further, as described with respect to FIGS. 1 and 2B. The trained neural network 102 may be trained with additional training meshes prior to receiving the deformed mesh 701.

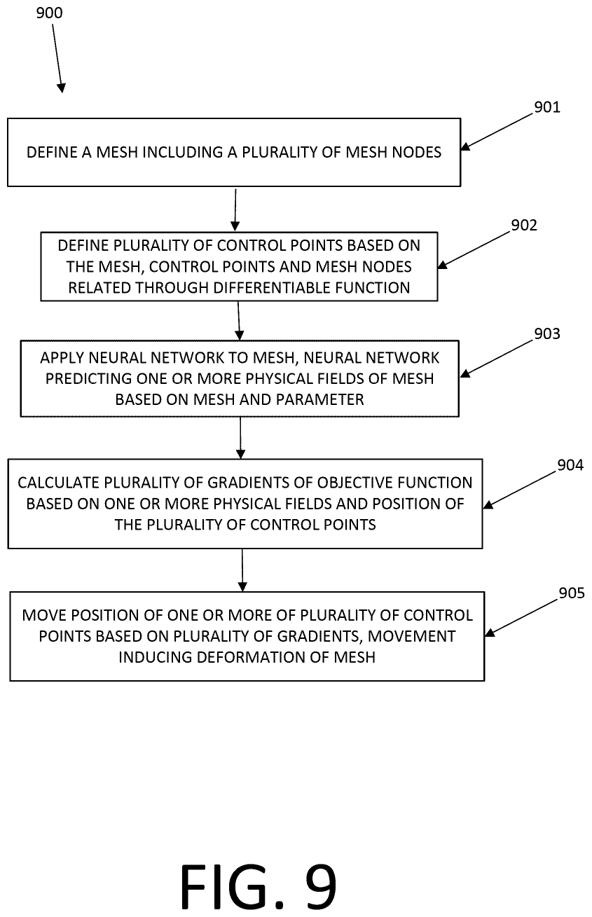

FIG. 9 depicts an example method of generating a geometric shape, in accordance with some embodiments. The method 900 includes a first step 901 of defining a mesh that includes a plurality of mesh nodes. At 902, a plurality of control points is defined based on the mesh. The control points and mesh nodes are related through a differentiable function. At 903, a neural network is applied to the mesh. The neural network predicts one or more physical fields of the mesh based on the mesh and a parameter. At 904, a plurality of gradients of an objective function are calculated based on one or more physical fields and a position of the plurality of control points. At 905, the position of one or more of the plurality of control points are moved based on the plurality of gradients. The movement induces a deformation of the mesh.

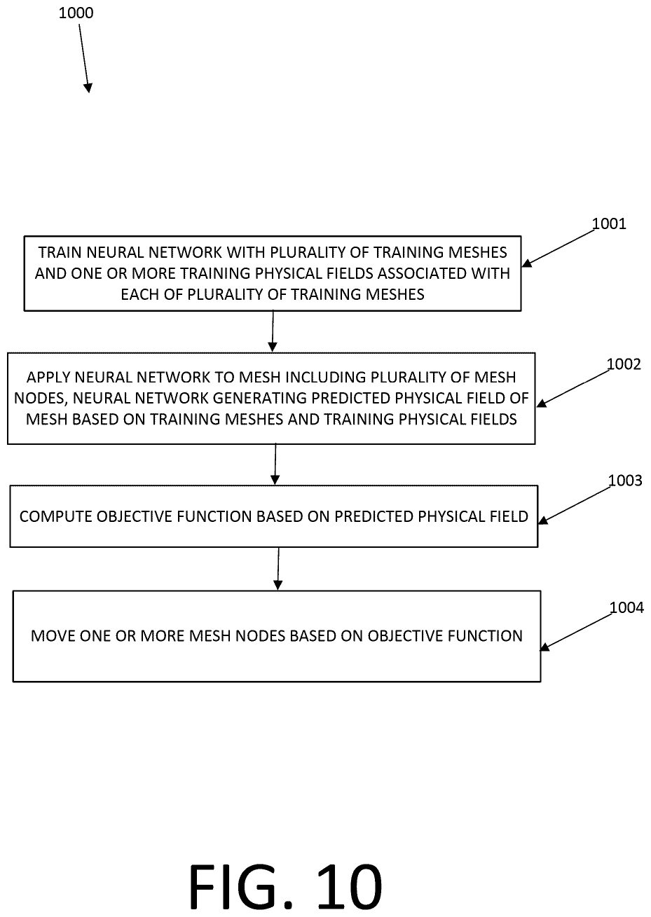

FIG. 10 depicts an example method of generating a geometric shape, in accordance with some embodiments. The method 1000 includes a first step 1001 of training a neural network with a plurality of training meshes and one or more training physical field associated with each of the plurality of training meshes. At 1002, a neural network is applied to a mesh that includes a plurality of mesh nodes. The neural network generates a predicted physical field of the mesh based on the training meshes and the training physical fields. At 1003, an objective function is computed based on the predicted physical field. At 1004, one or more mesh nodes are moved based on the objective function.

The methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein. In some embodiments, systems and methods utilize Python, object-oriented software code. That software code operates via one or more CPUs that are in communication with one or more arrays of graphical processing units (GPUs). Those GPUs may be utilized in the training of the neural network, and in certain embodiments those GPUs can be used to execute trained neural networks in a production environment.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

It is claimed:

1. A method of generating a geometric shape, the method comprising:
defining a mesh including a plurality of mesh nodes;
defining a plurality of control points based on the mesh, the control points and mesh nodes related through a differentiable function;
applying a neural network to the mesh, the neural network predicting one or more physical fields of the mesh based on the mesh and a parameter;
calculating a plurality of gradients of an objective function based on the one or more physical fields and a position of the plurality of control points; and
moving the position of one or more of the plurality of control points based on the plurality of gradients, the movement inducing a deformation of the mesh.

2. The method of claim 1, further comprising repeating the application of the neural network, the calculation of the plurality of gradients, and the movement of the position of the control points until the objective function converges.

3. The method of claim 2, further comprising validating the mesh after the objective function converges, the validation including applying a physical solver to the mesh.

4. The method of claim 1, further comprising applying a morphing algorithm to the plurality of control points.

5. The method of claim 4, further comprising training the neural network with the mesh.

6. The method of claim 1, further comprising training the neural network with a plurality of training meshes and one or more physical fields of each of the plurality of training meshes.

7. The method of claim 1, further comprising defining one or more constraints of the mesh nodes.

8. The method of claim 7, wherein the movement of the one or more control points is based on the one or more constraints.

9. The method of claim 1, wherein the plurality of control points form a lattice.

10. A method of generating a geometric shape, the method comprising:
training a neural network with a plurality of training meshes and one or more training physical fields associated with each of the plurality of training meshes;
applying the neural network to a mesh including a plurality of mesh nodes, the neural network generating a predicted physical field of the mesh based on the training meshes and the training physical fields;
computing an objective function based on the predicted physical field; and
moving one or more of the mesh nodes based on the objective function.

11. The method of claim 10, further comprising defining a plurality of control points based on the mesh, the control points and mesh nodes related through a differentiable function.

12. The method of claim 11, further comprising moving one or more of the control points, the movement of the one or more mesh nodes based on the movement of the one or more control points.

13. The method of claim 11, further comprising computing a plurality of gradients of the objective function based on the predicted physical fields and the control points.

14. The method of claim 11, further comprising applying a morphing algorithm to the plurality of control points.

15. The method of claim 10, further comprising repeating the application of the neural network, the computation of the objective function, and the movement of one or more mesh nodes until the objective function converges.

16. The method of claim 15, further comprising validating the mesh after the objective function converges, the validation including applying a physical solver to the mesh.

17. The method of claim 16, further comprising training the neural network with the mesh.

18. The method of claim 10, further comprising defining a constraint of one or more of the mesh nodes.

19. The method of claim 18, wherein the movement of the one or more mesh nodes is based on the constraint of the one or more mesh nodes.

20. The method of claim 10, wherein the plurality of control points form a lattice.
